(19) United States
(12) Patent Application Publication
(10) Pub. No.: US 2007/0226892 A1
(43) Pub. Date: Oct. 4, 2007

(54) Bath Aeration

(75) Inventors: Timothy V. Strickland, Auckland (NZ); Kipley Roydon Marks, Auckland (NZ)

Correspondence Address: EDWARDS ANGELL PALMER & DODGE LLP, P.O. BOX 55874, BOSTON, MA, 02205, US

(73) Assignee: Kipley Roydon Marks, Auckland (NZ)

(21) Appl. No.: 10/558,999

(22) PCT Filed: May 28, 2004
(86) PCT No.: PCT/NZ04/00107

§ 371 Date: Apr. 24, 2007

(30) Foreign Application Priority Data
May 30, 2003 (NZ) 526225
Jun. 16, 2003 (NZ) 526549

(51) Int. Cl. A61H 33/02

(52) U.S. Cl. 4/541.4

(57) ABSTRACT

An aerated bath is disclosed which allows an effervescent effect to be provided. A liquid flow (56) including a significant volume of entrained air bubbles (10) is ejected into the bath such that the flow follows the base (54) of the bath under the influence of the Coanda effect. Once the transport velocity of the liquid flow is too low for continued entrainment of the bubbles they rise to the surface to provide the effervescent effect.

### FIELD OF THE INVENTION

This invention relates to methods and apparatus for aeration of baths.

### BACKGROUND TO THE INVENTION

Baths in which the bath water is aerated with bubbles are well known. Producing bubbles in bath water is generally intended to have one of two effects.

The first effect is a substantial massaging effect. There are two ways to achieve this.

One way is to use one or more jets, such as those which are frequently referred to as spa jets, whirlpool jets, or hydrotherapy jets to eject a relatively high speed flow of water which carries large air bubbles. These air bubbles are usually introduced into the water stream by a process of entrainment that occurs as a result of a venturi effect. The bubbles act to interrupt the flow of fluid that impinges upon the body of a user of the bath. Because the fluid is ejected from the nozzle at a relatively high speed, the interrupted flow tends to provide an impact upon the user's body, and this provides a physical massaging effect. That is to say the effect is more than merely felt on the user's skin, but exerts a force that is felt as a varying physical pressure on the user's body.

Therefore, to achieve this effect, spa jets are usually located in a central upper portion of the bath wall, and eject a high velocity stream of liquid directly into the centre of the bath. Although many hydrotherapy jets have adjustable outlet nozzles, the general thrust of the jet is essentially horizontal so that the fluid flow impinges directly upon a user's body (for example the user's back). If the fluid flow is not interrupted by the body of the user, then the fluid stream ejected by each jet will usually have the effect of travelling across a large portion of the bath, often from one wall of the bath to the opposite wall. Since the bubbles are large, and the fluid flow is rapid, these systems are frequently noisy and create a significant disturbance of the water in the bath.

The second way is to inject the air under pressure from a blower through a series of holes in the bath base or a series of fittings in the base. The bubbles thus created tend to be large and as they rise from the base they impact on the bather causing a massaging effect not dissimilar from the effect mentioned above, but again they are noisy and create a significant disturbance of the water in the bath.

The second effect that some bubble producing apparatus in baths seek to achieve is one where relatively small bubbles of air are introduced to the bath so that the bubbles gently touch the skin of a user. Rather than the forceful massaging effect described above, this effect is one where the small bubbles tend to pass gently over or cling to the skin of a user, or break gently on the skin of the user so that the user feels a tingling sensation. That is to say that the user's nervous system at the skin surface is stimulated by the presence of the air bubbles. Unlike the massaging effects described above, the user does not feel any substantial flow of liquid impinging on his or her body. In this document this second effect is referred to generally as an effervescent effect.

Known devices which produce bubbles that rise from the base of a bath include those that are known as “air bubblers”. These are provided in the base of baths to generate bubbles that are formed in the base of the bath and rise upwardly toward the surface.

In some installations such as that shown in the specification for European Patent 0353596, a number of fittings with apertures are installed in the base of the bath and an air blower is used to blow air up through the apertures. A dome is provided over each aperture in order to provide an aesthetically attractive cover over the aperture, while still allowing air to pass through the apertures and into the bath. A non-return valve can also be provided in each fitting to prevent the drainage of water from the bath into the fitting and its associated pipe work.

In practice, these known constructions have a number of disadvantages. Firstly, despite the non-return valve, water tends to drain from the bath through the apertures and leads to a cleaning or hygiene problem. Secondly, the apertures effectively become blocked when a user sits on them in the bath. Thirdly, the bubbles produced by the existing apparatus tend to be large and make a significant noise when they break at the surface. Fourthly, a separate air blower is required to provide the necessary airflow and this adds to the noise experienced by a user. Lastly, the domes are uncomfortable for users to sit on.

Air bubblers tend to produce large bubbles despite relatively small apertures being used because the bubbles tend to adhere to the apparatus in immediate vicinity of each aperture. The bubbles so formed tend to require a significant amount of air to accumulate before the bubble has sufficient volume to break free from the surface to which it is attached.

To create an effervescent effect this problem can be overcome by introducing further design features such as directing a small jet of water in the vicinity of each aperture to encourage the bubble to break away more quickly. However, this additional complexity significantly increases the cost of the system and can lead to further maintenance (for example cleaning) and drainage problems.

Another air bubbler apparatus which is disclosed in U.S. Pat. No. 6,601,246 uses a form of bath mat that has a cavity and number of air apertures so that air may be released from the cavity into the bath through the apertures. To supply air, a blower is connected to an inlet to the cavity. Although this apparatus has the advantage that it does not require modification of the bath itself, it still has the problems of requiring an additional air blower unit, the production of bubbles which are too large to provide the desired effect, the noise of the large breaking bubbles, and the fact that a number of apertures are blocked when a user sits on the mat.

In U.S. Pat. No. 6,360,380 a soaker bath tub that may produce a low volume of very small air bubbles is disclosed. The small bubble size is achieved by entraining air into the recycled bath water flow through a very small aperture (0.015 inches in diameter) upstream of the pump impeller that creates the water flow. The entrained bubbles must pass through the impeller and in so doing they are broken into yet smaller bubbles for delivery into the bath. The very small resulting bubble size (the bubbles in practice have an average size of less than approximately 3 mm in diameter) can provide an aesthetically pleasing visual effect. However, bubbles that are so small tend not to provide a sensory effect to a bath user, particularly when the bubble volume is low. Significant bubble volume cannot be achieved by the bath apparatus disclosed in United U.S. Pat. No. 6,360,380 because the volume of air entrained in the water flow upstream of the impeller must be limited to prevent cavitation about the impeller. Cavitation causes loss of flow and creates unwanted noise.

### OBJECT

It is an object of the present invention to provide a bath aeration method or apparatus which will at least go some way toward overcoming one or more of the disadvantages referred to above, or which will at least provide the public with a useful alternative.

### BRIEF SUMMARY OF THE INVENTION

Accordingly in one aspect the invention provides a bath having a base and at least one side wall dependant therefrom, at least one nozzle mounted in the wall to eject a flow of liquid including entrained air bubbles into the bath, whereby in use the flow leaves the nozzle with a velocity and in a direction such that the majority of the air bubbles reach the surface of liquid contained in the bath in a central region of the bath and attain a predominantly vertical direction of motion toward the surface upon or before reaching the central region.

The nozzle may include an air inlet and a liquid inlet and bubbles are preferably entrained in the liquid by venturi action.

In a preferred embodiment the nozzle is directed toward the base of the bath. The nozzle is directed so and the flow velocity is such that in use the bubbles substantially reach the base of the bath before rising.

The nozzle may be directed such that the flow is substantially parallel with and adjacent to the wall of the bath in a direction toward the base of the bath.

In another preferred embodiment the nozzle may include a liquid outlet and an air outlet with the air outlet downstream of the liquid outlet and being arranged such that air from the air outlet is entrained in the liquid from the liquid outlet to thereby provide the flow of liquid and entrained air bubbles.

In a further aspect the invention provides a method of aerating a bath, the method including the steps of ejecting, from a wall of the bath, a liquid flow including entrained air bubbles, and providing the flow with a velocity and a direction such that the majority of the air bubbles reach the surface of liquid contained in the bath in a central region of the bath and attain a predominantly vertical direction of motion toward the surface of the bath upon or before reaching the central region.

In a still further aspect the invention provides a bath aeration device having an air inlet, a liquid inlet, an outlet nozzle, entrainment means to allow a liquid flow including entrained air from the air inlet to exit the outlet nozzle, and the outlet nozzle being adapted to direct the liquid flow in direction substantially parallel to a side wall of a bath.

The outlet nozzle may include an air outlet and a liquid outlet and the entrainment means may allow a liquid stream from the liquid outlet to have air bubbles entrained therein from the air outlet to thereby provide the liquid flow.

In still another aspect the invention provides a bath having a base and at least one side wall dependant therefrom, at least one nozzle mounted in the wall to eject a flow of liquid including entrained air bubbles into the bath, the nozzle being mounted in sufficient proximity to the base and being directed whereby in use the flow follows at least a part of the base under the influence of a boundary layer condition.

In a further aspect the invention provides a bath having a base and at least one side wall dependant therefrom, at least one nozzle to eject a flow of liquid including entrained air bubbles into the bath, the nozzle being mounted to direct the flow relative to the wall or the base such that in use the flow follows the wall and/or the base under the influence of a boundary layer condition.

In yet a further aspect the invention provides a method of aerating a bath, the method including the steps of ejecting a liquid flow including entrained air bubbles, and providing the flow with a direction such that the flow follows the wall and/or a base of the bath under the influence of a boundary layer condition.

Further aspects of the invention will become apparent from the following description.

Where it appears in this document, the word “comprise” or variants such as “comprising” or “comprises” is to be interpreted in an inclusive sense.

### DRAWING DESCRIPTION

One or more preferred embodiments of the invention will be described below by way of example with reference to the following drawings, in which:

FIG. 1: is a partial side elevation in cross section through line A-A of the bath of FIG. 2;

FIG. 2: is a diagrammatic plan view of the bath shown in cross-section in FIG. 1;

FIG. 3: is an alternative side elevation in partial cross section through line A-A of the bath of FIG. 2;

FIG. 4: is a plan view of a nozzle according to the invention;

FIG. 5: is a side elevation in cross section through Line B-B of FIG. 4 where the apparatus is provided in the wall of a bath;

FIG. 6: is a side elevation and cross section of a bath including the apparatus of FIG. 5; and

FIG. 7: is a side elevation in cross section of an alternative nozzle provided in the wall of a bath.

### DETAILED DESCRIPTION

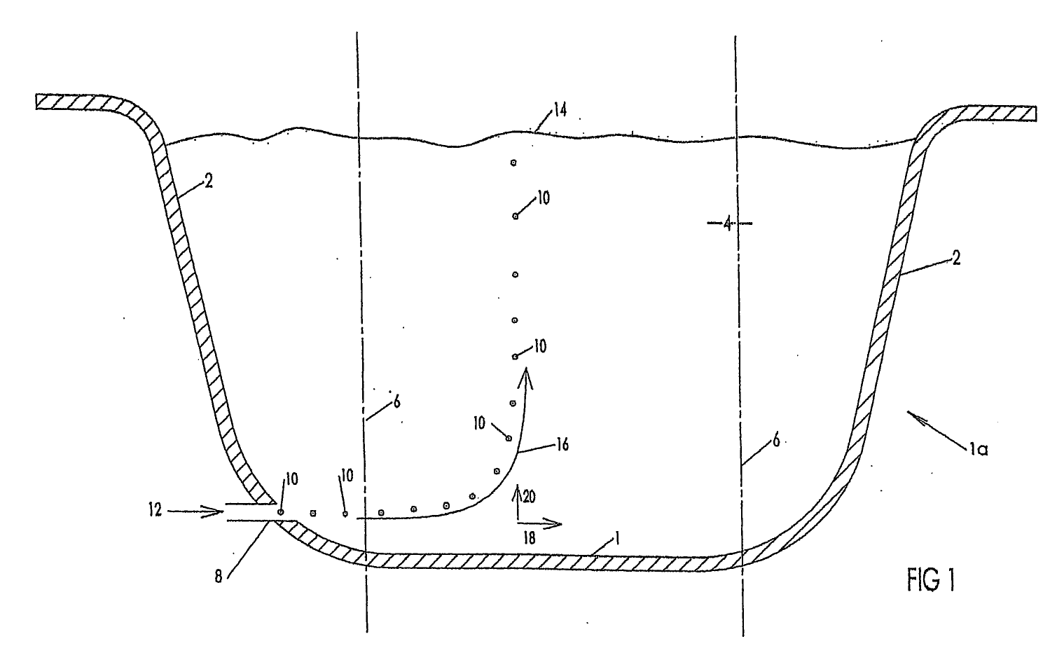

Referring to FIG. 1, a first embodiment of the invention is shown. A bath 1a having a base 1 and side or end walls 2 is filled with a volume of bath water 4. For the purposes of this description and interpretation throughout this document, references to the walls 2 of the bath refer to that section of the bath which is non-horizontal. That is to say, the base 1 as shown in FIG. 1 ends at broken lines 6 and it is at this point that the walls 2 begin. Of course, the bath may be a variety of different shapes, and the walls 2 may simply comprise a single wall (for example circular wall) that is dependent from the base 1 rather than clearly defined individual wall portions.

An outlet 8 is provided with an apparatus (not shown) that produces a flow of water with small entrained air bubbles 10 and introduces the flow into the bath is indicated by arrow 12. Pumping and associated reticulation apparatus for producing a water flow in baths by drawing water from the bath and reintroducing it is well known to those skilled in the art and is readily available.

The flow direction and velocity of the water introduced to the bath through outlet 8 is such that the majority of the small air bubbles 10 reach the surface 14 in a central region of the bath and attain a predominantly vertical direction of motion toward the surface 14 of the bath upon or before reaching a central region of the bath. Therefore, unlike spa baths which provide a massaging effect to users, the flow is such that the bubbles do not reach the far side of the bath before having a predominantly vertical upward direction of motion. Also, unlike spa baths, the water flow does not have a significant impact on the body of the user.

The general flow path of the air bubbles 10 is indicated by arrow 16. The motion of each air bubble 10 at any point along the flow path may be resolved into a horizontal and a vertical component of motion. The horizontal component of motion is indicated by arrow 18 and the vertical component of motion is indicated by arrow 20. Initially, the bubbles 10 have a predominantly horizontal component of motion, being carried by the water flow which in this embodiment of the invention exits the outlet 8 in a substantially horizontal direction. Thus the vertical component of motion is almost zero when the bubbles exit the outlet 8. However, by the time the bubbles have reached a central portion of the bath, the water flow velocity has dropped and the bubbles cease to be entrained in the flow so the predominant component of motion is vertical rather than horizontal. This bubble flow path results in bubbles that gently contact the body of a bather as they rise to the surface 14.

The central region of the bath may be generally defined as the region which would be normally occupied by the intended user or users of the bath. For example, in FIG. 1, the central region would typically be the region between the broken lines 6.

We have found that the flow path described above allows bubbles to be introduced into the bath so as to provide a pleasing effervescent effect for the user. The flow velocity is such that, by the time the flow reaches the central region of the bath, the velocity is sufficiently low that it is barely perceptible to a user. Since we can entrain a large number of small bubbles into the water flow 12, the effect for the user is a large number of rising bubbles which are perceived as a tingling or light touching sensation on the user's skin.

Furthermore, because the bubbles are small in size, and because the flow velocity is low, there is substantially no noise associated with either the breaking bubbles. This enhances a user's bathing experience.

In our most preferred embodiment, we have also found that a desirable average bubble size is in the range of approximately 3 mm to 8 mm diameter for providing the effervescent effect. This is in contrast to bubbles delivered by spa or whirlpool jets, which are on average at least 10 mm in diameter. We achieve our preferred bubble size in our most preferred embodiment of the invention by using a nozzle that entrains air therein by a venturi effect i.e. a venturi-type nozzle. Such a nozzle may take a variety of different forms, two of which are described further below.

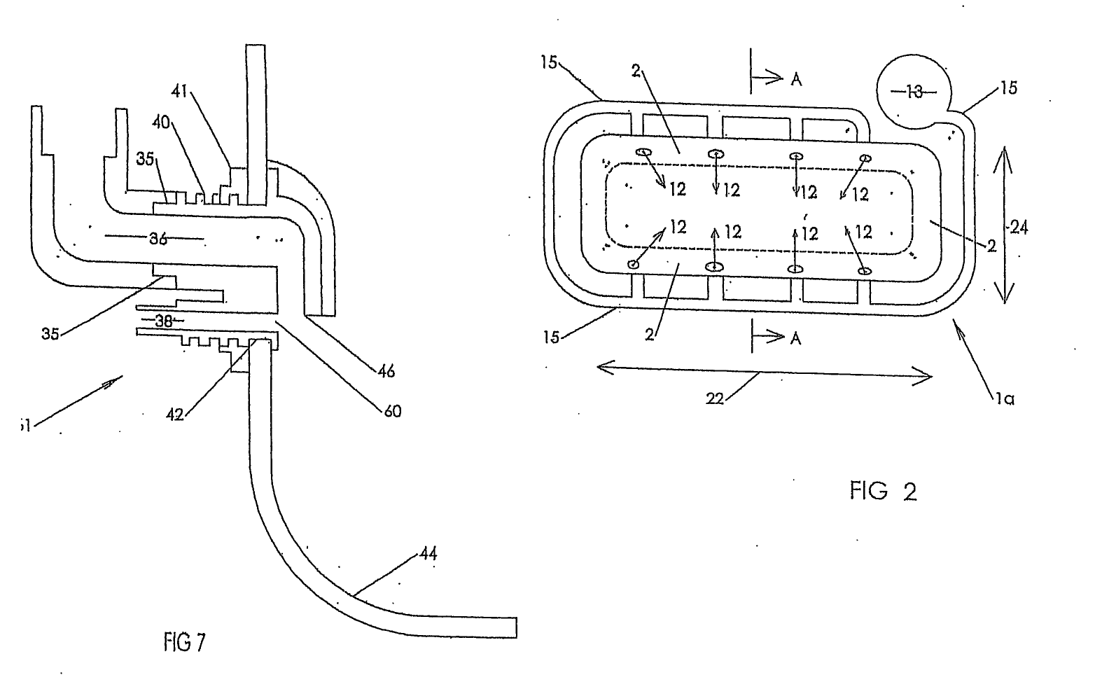

Turning to FIG. 2, a plan view of the bath 1a which is shown in cross-section in FIG. 1 is diagrammatically depicted. The bath will typically have a pump 13 which circulates water from the bath to the outlets 8 via a reticulation system of pipes such as pipes 15. This bath is one example of a typical bath in which the invention may be implemented. Such a bath may have a longitudinal dimension 22 of approximately 1800 mm and a lateral dimension 24 in the range of approximately 700 mm to 900 mm. The central region occupied by a bather of such a bath may typically be 1300 mm-1500 mm in the longitudinal direction and 450 mm-600 mm in the lateral direction. Referring to FIG. 2, a number of outlets 8 are illustrated together with arrows 12 which show the general direction of flow of the liquid and entrained air bubbles that exit each of the outlets. In our most preferred embodiment eight to twelve nozzles are used, however this number may vary depending on the size of the bath and the bather's requirements. As can be seen form the drawing figure; the direction of flow of each outlet may be selected to introduce desired regions of concentrations of bubbles within the bath. For example, the outlets 8 that are adjacent to the ends of the bath may have a greater outlet flow velocity, but be directed in such direction that the desired flow path in the vertical direction and into the central region is still achieved.

The one or more outlet nozzles 8 are preferably provided in a lower portion of the relevant bath wall 2, so that the bubbles may rise to assume the flow path described with reference to FIG. 1.

In a preferred embodiment a large volume of air is entrained in the water flow entering the bath to provide a significant volume of bubbles. We have found that that more bubbles lead to an increased effervescent effect being perceived by the bather. In general, for a given volume of water, increasing volumes of air can be entrained in the water as the velocity of the water flow increases. However, as the fluid velocity through outlet nozzles 8 is increased there is an increasing risk that the fluid flow will impact on the bather's body and negate the desired sensory effect of the bubbles.

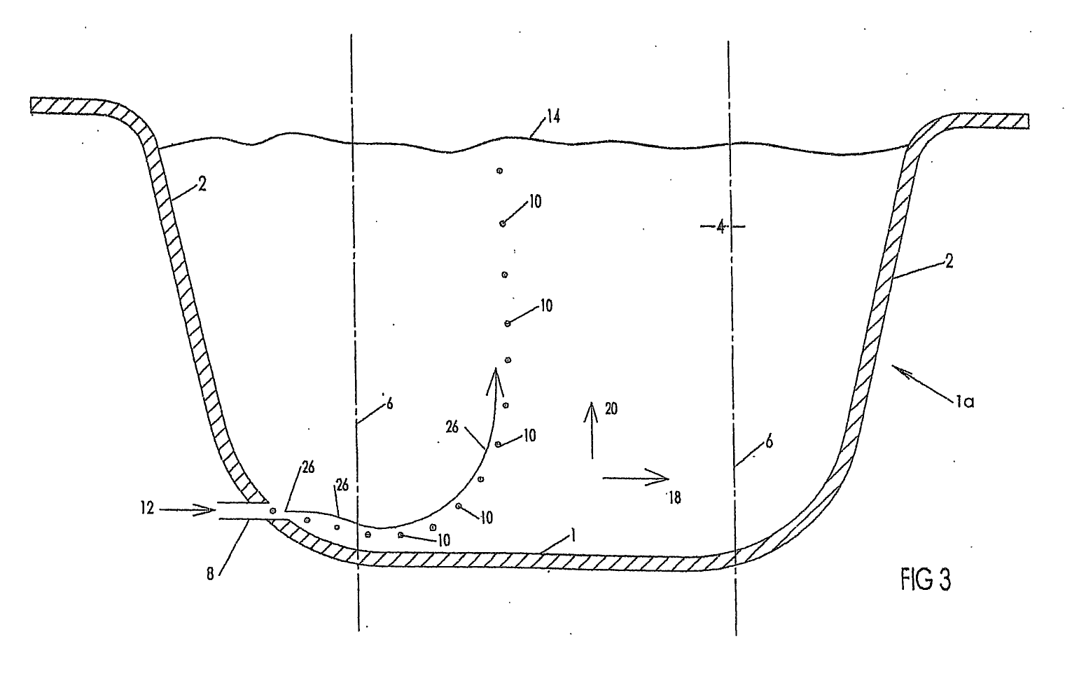

Referring to FIG. 3, we have found this problem can be overcome by appropriate location and direction of the outlets 8. As shown in FIG. 3 the outlet is directed so that the flow 12 is in a generally horizontal direction, but the outlet is slightly closer to the base 1 of the bath than in the embodiment shown in FIG. 1. We have found that the flow path adopted by the flow from the outlet takes the form shown by arrow 26. As shown in the drawing, the flow follows the lower part of the wall 2 and travels along the base 1. As the flow travels further from the outlet 8 it diffuses and slows until the velocity of the flow falls below the entrainment velocity necessary to entrain the bubbles 10 which then rise toward the surface 14. We believe that this flow path along the side wall and/or base of the bath is due to a boundary layer condition known as the Coanda effect. Employing this effect has the advantage that the long flow path along the wall/base allows the water 4 in the bath to act as a diffuser to diffuse the bubbles effectively as the flow velocity decreases and the long flow path delivers the bubbles effectively to a central region of the bath so that they rise about the body of the user. Therefore, the effect provides an effective delivery mechanism for the bubbles. Also, because there is a long flow path we have found that a relatively high nozzle outlet velocity can be used without having a detrimental affect on the effervescent effect experienced by a bather. This means that a high volume of air may be entrained resulting in many more bubbles being delivered. The Coanda effect provides the desirable characteristics of the flow path described above with reference to FIG. 1, but with the further improvement of a longer path that is capable of keeping the bubbles in the lower position in the bath so that they are kept away from the bather until being released in a central region of the bath to rise effectively about the bather.

Therefore, in our preferred embodiment, as much air as possible is entrained in the water flow. We have found that a ratio in the range of approximately 1.5:1 air:water provides a desirable effect.

Our experiments have shown that the Coanda effect can influence the fluid flow from the outlet 8 when a horizontally directed outlet is in the order of 70 mm to 100 mm from the base 1 of the bath. The closer the outlet is to the base, the more pronounced the effect. In preferred embodiments of the invention the outlet 8, if mounted in a side wall 2 and directed substantially horizontally, is located not more than 75 mm vertically above the base 1.

The length of the flow path from the outlet can be increased further using the Coanda effect by locating the outlet further away from the base and directing the flow along the side wall with at least a component of flow being directed toward the base 1. This is described further below.

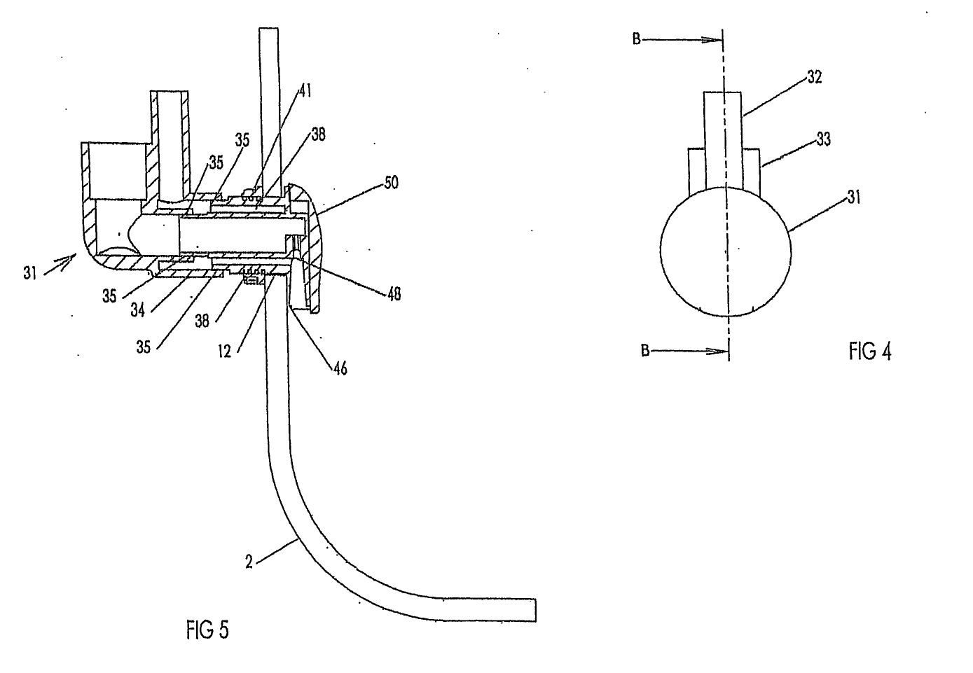

Referring to FIG. 4, an exemplary embodiment of an outlet nozzle for mounting in a bath wall above the base is shown generally referenced 31. The nozzle has an air inlet 32 and a liquid or water inlet 33, and is shown in greater detail in cross-section in FIG. 5.

Referring to FIG. 5, the outlet nozzle is shown to have a body 34 that provides a central liquid passageway 36 and an air passageway 38. The body may be provided in two separate parts for ease of installation. The regions of interconnection between the two parts are indicated by reference 35. An external part of the body includes a thread 40 that engages with a complementary thread provided on a nut 41 that is used to secure the body through an aperture 42 in a bath wall 2. The nozzle 31 includes an outlet nozzle 46 and a restricted region 48 is provided to create a venturi effect so that liquid that exits the nozzle has air bubbles entrained therein from the air inlet 32 through aperture 37. The restrictive portion 48 at which entrainment occurs may be provided in the nozzle outlet 46, or at another location within the body of nozzle 31. In a preferred embodiment the nozzle 46 is in the order of 5 mm in diameter, the nozzle is operated at approximately 40 kPa water pressure to displace approximately 8 litres of air per minute and has an outlet velocity of approximately 40 metres per second.

In order to provide an aesthetically pleasing finish a cap 50 is preferably provided which can be engaged over an outer portion of nozzle 46 by a snap fit for example.

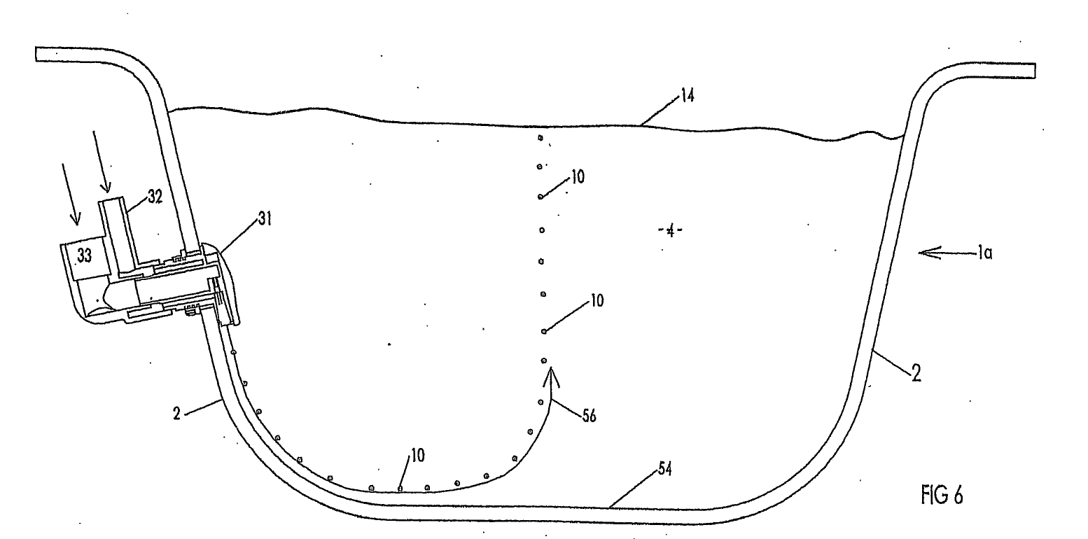

Turning now to FIG. 6, the nozzle apparatus of FIGS. 4 and 5 is shown in use mounted in a side wall 2 of a bath 1a. The bath contains water 4 in use. As can be seen from the drawing, the outlet nozzle directs the fluid flow from the outlet towards the base 1 of the bath in a direction adjacent to an interior surface of side wall 2 and substantially parallel to the side wall. Although the direction is shown in the drawing figure as being directly downward toward the base, it will be appreciated that the flow may be directed along the wall at an angle relative to the base, for example forty five degrees relative to the base.

Furthermore, the nozzle outlet does not have to be directed completely parallel and directly adjacent to the wall. The Coanda effect occurs when a fluid flows along a surface, and adheres to it until broken free by a sharp change in direction of the wall or by some other external force. Therefore as long as the direction of flow is not angled too sharply away from the bath wall 2 (or the base 1 depending on where in the wall the outlet is located), the water from the nozzle, with its entrained air bubbles, will flow down the wall and/or along the base (because there is a smooth transition between the wall 2 and the base 1) until the point where the transport velocity is too low for continued entrainment and so the bubbles rise to the surface.

The nozzle 31, particularly the restrictive region 48, is arranged to provide a stream of air bubbles 10. Those skilled in the art will appreciate that, although the bubbles are shown in the preferred embodiment as being provided by being entrained in a liquid flow similar to that in operation of a spa nozzle, the volume of bubbles could possibly be increased by a blower or similar device.

The arrangement of a number of these nozzles 31, creates the effect of air bubbles travelling down the side walls until they reach the base of the bath and then rising substantially in a central region of the bath. This flow of air bubbles is illustrated in FIG. 6 by arrow 56. Therefore, the effect that is provided is the desired effect of bubbles rising from the base of the bath.

It will be seen that the outlet nozzle 46 may be designed so that the nozzle can function to provide an outlet flow which is substantially horizontal such as the flow path shown in FIG. 1.

Turning now to FIG. 7, an alternative embodiment of an outlet nozzle arrangement according to the invention is illustrated. Like reference numerals in FIG. 7 represent like features that have been described above with reference to the preceding drawings.

The nozzle of the embodiment shown in FIG. 7 also provides the same benefits and general function as that described with reference to FIGS. 4 to 6 above.

The primary difference between the nozzle arrangement 61 of FIG. 7 is that the air passageway 38 has an air outlet 60 which is provided downstream of liquid outlet 46. Thus in use, liquid such as bath water which is provided through liquid passageway 36 exits the nozzle outlet 46 and is directed substantially downwardly adjacent to and parallel with the side wall 44 of the bath toward the base of the bath. The liquid passes air outlet 60. At this point, depending upon the characteristics of the liquid flow, such as velocity for example, air may be entrained in the liquid flow by a venturi effect adjacent to air outlet 60 so that there is a stream of air bubbles entrained in the liquid flow. Alternatively, the air passageway 38 may be supplied by an air blower i.e. a supply of air at a desired pressure so as to create an increased air flow through passageway 38 and out air outlet 60. In this fashion, a stream of bubbles is produced which is carried by the liquid flow along the side wall of the bath toward the base of the bath. It would be seen that the air outlet 60 could be provided very close to the liquid outlet 46. Alternatively, there could be quite some distance between the liquid outlet and the air outlet 60, and it will be seen that the air outlet 60 and the air passageway 38 could be supplied as a completely separate component from the liquid outlet nozzle part of the assembly.

The invention has the advantages that no apertures are required in the base of the bath, so drainage into pipe work does not occur. Also, since in the most preferred embodiments the nozzle is directed downwardly, the nozzle assembly tends to drain freely into the bath so maintenance and cleaning problems are reduced. The base of the bath is also freed from any associated obstacles or protrusions. Also, the provision of relatively small bubbles means that bubble noise is reduced. Finally, the apparatus has a significant advantage in that it can be used in conjunction with existing spa or whirlpool bath reticulation i.e. the spa or whirlpool pump provides water flow into the water inlet of the nozzle. Therefore, a separate air blower (which adds to expense and creates undesirable noise) is not required, but can be fitted if desired.

The preferred features of the invention are applicable to all aspects of the invention and may be used in any possible combination.

Wherein the foregoing description reference has been made to specific components or integers of the invention having known equivalents then such equivalents are herein incorporated as if individually set forth.

1. A bath having a base and at least one side wall dependant therefrom, at least one nozzle mounted in the wall to eject a flow of liquid including entrained air bubbles into the bath in a direction toward the base of the bath, whereby in use the flow leaves the nozzle with a velocity and in a direction such that the majority of the air bubbles reach the surface of liquid contained in the bath in a central region of the bath and attain a predominantly vertical direction of motion toward the surface upon or before reaching the central region.

2-3. (canceled)

4. A bath as claimed in claim 1 wherein the nozzle is directed and the flow velocity is such that in use the bubbles substantially reach the base of the bath before rising.

5. A bath as claimed in claim 1 wherein the nozzle is directed such that the flow is substantially parallel with and adjacent to the wall of the bath in a direction toward the base of the bath.

6. A bath as claimed in claim 5 wherein the nozzle is directed and the flow velocity is such that in use the bubbles substantially reach the base of the bath before rising.

7. A bath is claimed in claim 1 wherein the nozzle includes an air inlet and a liquid inlet and bubbles are entrained in the liquid by venturi action.

8. A bath as claimed in claim 7 wherein the nozzle includes a liquid outlet and an air outlet and the air outlet is downstream of the liquid outlet and is arranged such that air from the air outlet is entrained in the liquid from the liquid outlet to thereby provide the flow of liquid and entrained air bubbles.

9. A bath as claimed in claim 4 wherein the flow follows at least a part of the base before rising.

10. A bath as claimed in claim 9 wherein the flow follows the base under the influence of the Coanda effect.

11. A method of aerating a bath, the method including the steps of ejecting, from a wall of the bath, a liquid flow including entrained air bubbles in a direction toward the base of the bath, and providing the flow with a velocity and a direction such that the majority of the air bubbles reach the surface of liquid contained in the bath in a central region of the bath and attain a predominantly vertical direction of motion toward the surface of the bath upon or before reaching the central region.

12-13. (canceled)

14. A method as claimed in claim 11 including directing the flow and adjusting the velocity of the flow such that in use the bubbles substantially reach the base of the bath before rising.

15. A method as claimed in claim 11 including directing the flow substantially parallel with and adjacent to a side wall of the bath in a direction toward the base of the bath.

16. A method as claimed in claim 15 including directing the flow and adjusting the velocity of the flow such that in use the bubbles substantially reach the base of the bath before rising.

17. A method as claimed in claim 14 including directing the flow and adjusting the velocity of the flow such that the flow follows at least a part of the base before rising.

18. A method as claimed in claim 17 including using the Coanda effect to influence the flow to follow the base.

19. A bath aeration device having an air inlet, a liquid inlet, an outlet nozzle, entrainment means to allow a liquid flow including entrained air from the air inlet to exit the outlet nozzle, and the outlet nozzle being adapted to direct the liquid flow in a direction substantially parallel to a side wall of a bath.

20. A device as claimed in claim 19 wherein the outlet nozzle includes an air outlet and a liquid outlet and the entrainment means allow a liquid stream from the liquid outlet to have air bubbles entrained therein from the air outlet to thereby provide the liquid flow.

21. A bath having a base and at least one side wall dependant therefrom, at least one nozzle mounted in the wall to eject a flow of liquid including entrained air bubbles into the bath, the nozzle being mounted in sufficient proximity to the base and being directed whereby in use the flow follows at least a part of the base under the influence of a boundary layer condition.

22. A bath as claimed in claim 21 wherein the flow is ejected in a substantially horizontal direction.

23. A bath as claimed in claim 21 or claim 22 wherein the boundary layer condition comprises the Coanda effect.

24. A bath as claimed in claim 21 wherein the nozzle is mounted within a range of substantially 0 mm to 100 mm vertically above the base.

25. A bath having a base and at least one side wall dependant therefrom, at least one nozzle to eject a flow of liquid including entrained air bubbles into the bath, the nozzle being mounted to direct the flow relative to the wall or the base such that in use the flow follows the wall and/or the base under the influence of a boundary layer condition.

26. A bath as claimed in claim 25 wherein the nozzle is mounted in the wall and is directed toward the base.

27. A bath as claimed in claim 25 wherein the boundary layer condition comprises the Coanda effect.

28. A method of aerating a bath, the method including the steps of ejecting a liquid flow including entrained air bubbles, and providing the flow with a direction such that the flow follows the wall and/or a base of the bath under the influence of a boundary layer condition.

29. A method as claimed in claim 28 including ejecting the flow from a wall of the bath.

30. A method as claimed in claim 28 wherein the boundary layer condition comprises the Coanda effect.

31-33. (canceled)
